(19) United States
(12) Patent Application Publication
(10) Pub. No.: US 2015/0007704 A1
(43) Pub. Date: Jan. 8, 2015

(54) ULTRASONIC STEEL HORN FOR TIRE CUTTING AND METHOD OF MANUFACTURING

(71) Applicant: Branson Ultrasonics Corporation, Danbury, CT (US)

(72) Inventor: Francisco VIEIRA, Middlebury, CT (US)

(73) Assignee: BRANSON ULTRASONICS CORPORATION, Danbury, CT (US)

(21) Appl. No.: 14/293,532

(22) Filed: Jun. 2, 2014

Related U.S. Application Data
(60) Provisional application No. 61/843,529, filed on Jul. 8, 2013.

(51) Int. Cl. B26D 7/08; B29D 30/46; B22F 5/00

(52) U.S. Cl. CPC B26D 7/086; B22F 5/00; B29D 30/46; B22F 2005/001
USPC 83/651; 419/28

(57) ABSTRACT

An ultrasonic tuned blade includes a base and a tire cutting edge made of a tool steel having a vanadium content which is at least about 8 percent. For example, the tool steel can have a combined vanadium, cobalt, and tungsten content that is at least about 15 percent. The tool steel can be formed into a simple block via a powder metallurgy process. The simple block can be milled into an ultrasonic tire cutting horn shape comprising a tuned blade including a base and a tire cutting edge. The ultrasonic steel tire cutting horn can be heat treated to provide the tool steel with a Rockwell hardness, for example, of at least about 50 HRC and less than about 64 HRC. The ultrasonic steel tire cutting horn can include a low friction or wear resistant coating.

### CROSS-REFERENCE TO RELATED APPLICATIONS

This application claims the benefit of U.S. Provisional Application No. 61/843,529, filed on Jul. 8, 2013. The entire disclosure of the above application is incorporated herein by reference.

### FIELD

The present disclosure relates to ultrasonic horns for tire cutting.

### BACKGROUND

This section provides background information related to the present disclosure which is not necessarily prior art.

Ultrasonic horns for tire cutting are almost always made of titanium; typically, titanium 7-4 or titanium 6-4. Cutting rubber for tires with an ultrasonic horn, however, subjects the ultrasonic horn to extreme wear conditions. To ameliorate their rapid wear, titanium ultrasonic tire cutting horns are sometimes coated with a low friction coating such as titanium nitride.

Hardened steel is generally not seen as suitable for ultrasonic tire cutting horns. Hardened steels are much more difficult to machine and require additional processing steps, such as heat treatment. As a result, steel ultrasonic tire cutting horns are much more difficult and costly to manufacture. Another problem with steel ultrasonic tire cutting horns is they tend to draw meaningfully higher power, due to its greater thermal conductivity. Thus, as noted above, ultrasonic tire cutting horns are universally made from titanium.

### SUMMARY

This section provides a general summary of the disclosure, and is not a comprehensive disclosure of its full scope or all of its features, nor should every feature described herein be considered an essential feature of the disclosure.

In one aspect of the present disclosure, the ultrasonic steel tire cutting horn comprises a tool steel having a vanadium content that is at least about 8 percent.

In another aspect of the present disclosure, the ultrasonic steel tire cutting horn comprises a tool steel having a combined vanadium, cobalt, and tungsten content that is at least about 15 percent.

In yet another aspect of the present disclosure, the ultrasonic steel tire cutting horn comprises a tool steel that has been heat treated to a Rockwell hardness of at least about 50 HRC and less than about 64 HRC.

In an additional aspect of the present disclosure, a method of manufacturing the ultrasonic steel tire cutting horn comprises a powder metallurgical process.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective view of an exemplary ultrasonic steel tire cutting horn in accordance with the present disclosure.

FIG. 2 is a front elevation view of the ultrasonic steel tire cutting horn of FIG. 1.

FIG. 3 is a side elevation view of the ultrasonic steel tire cutting horn of FIG. 1.

FIG. 4 is a top plan view looking down on the cutting edge of the ultrasonic steel tire cutting horn of FIG. 1.

Corresponding reference numerals indicate corresponding parts throughout the several views of the drawings.

### DETAILED DESCRIPTION

Example embodiments will now be described more fully with reference to the accompanying drawings.

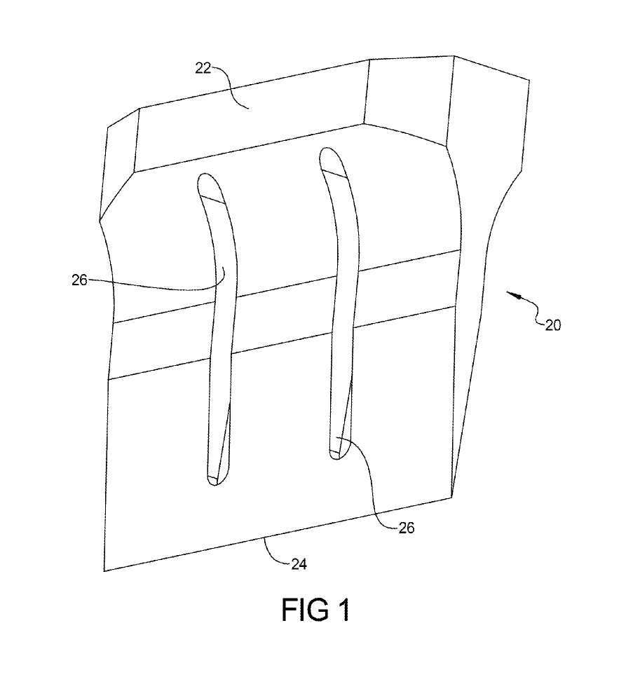

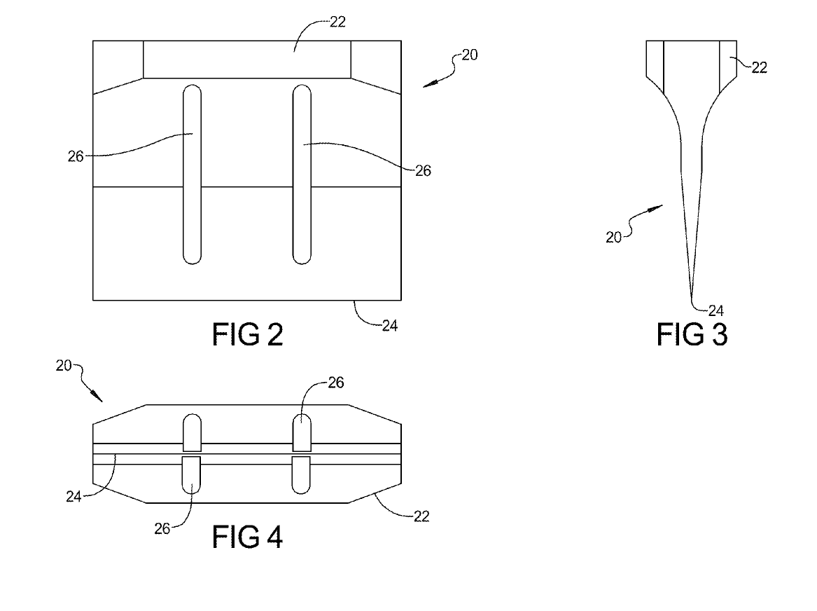

Referring to FIGS. 1-4, an exemplary ultrasonic steel tire cutting horn 20 is illustrated. The ultrasonic steel tire cutting horn 20 generally has a tuned blade shape including a base 22, a tire cutting edge 24, and one or more slotted apertures 26 extending through the cutting horn 20.

The ultrasonic steel tire cutting horn 20 can be manufactured from tool steels using a powder metallurgy process. Such processes, generally include manufacturing metal powders to achieve the appropriate composition, which can include blending various powdered metals together. The metal powder having the desired composition can be compacted and sintered or melted into a desired shape. Example processes can include 3D printing and hot isostatic pressing. Powder metallurgy manufacturing processes can provide a much more dense, homogeneous, and fine-grained microstructure than traditional steel casting processes.

In some cases, the initial desired shape can be a simple block that can be milled to closely approximate the overall dimensions of the ultrasonic steel tire cutting horn. An electrical discharge machining process can be used to achieve an essentially final blade shape of the ultrasonic steel tire cutting horn 20 as illustrated in the drawings. The ultrasonic steel tire cutting horn 20 in its essentially final blade shape can then be heat-treated to achieve a desired hardness and brittleness balance as discussed below. The cutting edge 24 can then be ground in order to refine or sharpen the cutting edge 24 prior to use.

In some cases, it may also be desirable to provide a low friction coating on the ultrasonic steel tire cutting horn 20. Thus, the ultrasonic steel tire cutting horn 20 can also be coated, for example, with a titanium nitride or other low friction or wear resistant coating.

Tool steels that are high in vanadium can be used for the ultrasonic steel tire cutting horn 20. For example, tool steel having a vanadium content of at least about 8 percent, or at least about 9 percent can be used. Such high vanadium content steels can additionally or alternatively have a vanadium content that is less than about 15 percent, or less than about 10 percent. Exemplary high vanadium content steels are commercially available, for example, from Crucible Industries of Solvay, N.Y. under their V series label, such as CPM 9V, CPM 10V, and CPM 15V.

Tool steels that are high in vanadium, cobalt, and tungsten can also be used for the ultrasonic steel tire cutting horn 20. For example, the tool steel can have a combined vanadium, cobalt, and tungsten content of at least about 15 percent, or at least about 17 percent. Such combined vanadium, cobalt, and tungsten content steels can additionally or alternatively be less than about 25 percent, or less than about 22 percent. Exemplary high combined vanadium, cobalt, and tungsten content steels are commercially available, for example, from Crucible Industries under their Rex series label, such as CPM Rex 45, CPM Rex 76, and CPM Rex 86. Such high combined vanadium, cobalt, and tungsten content tool steels are also commercially available, for example, from Hitachi Metals, Ltd. of Japan (or Hitachi Metals America, Ltd. of Purchase, N.Y.) under their Hap series label.

The tool steel of the ultrasonic steel tire cutting horn 20 can be heat treated to increase their strength and wear resistance. For example, the tool steel of the ultrasonic steel tire cutting horn 20 can be heat treated to have a Rockwell hardness of at least about 50 HRC, or at least about 55 HRC, or at least about 60 HRC, or at least about 61 HRC, or at least about 62 HRC. As the Rockwell hardness decreases, the wear resistance and thus the life span of the ultrasonic steel tire cutting horn 20 decreases.

The tool steel of the ultrasonic steel tire cutting horn 20 can additionally or alternatively be heat treated to have a Rockwell hardness of less than about 64, or less than about 63. Above such hardness levels, the brittleness or impact resistance of the ultrasonic steel tire cutting horn 20 can increase to unacceptable levels, causing the cutting edge 24 to become chipped or otherwise damaged. As such, the hardness and the brittleness of the ultrasonic steel tire cutting horn 20 should be balanced. Thus, in some cases, the steel can have a Rockwell hardness of between about 50 HRC and about 64 HRC, or between about 60 HRC and about 64, or between about 62 HRC and about 64, or another range defined by a combination of the HRC values identified above.

Initial indications are that a 40 Khz tire cutting horn 20 manufactured using the above-described process using CPM 10V (9.75 percent Vanadium) from Crucible Industries provides an ultrasonic steel tire cutting horn 20 having a thermal conductivity that is approximately 3 times higher than, and that will last at least three times longer than, a traditionally manufactured ultrasonic titanium tire cutting horn. Thus, the combination of higher thermal conductivity, and higher wear resistance offered by ultrasonic steel tire cutting horn 20 of this disclosure can provide meaningfully longer life span, or enable an increased duty cycle (cuts per minute), or both, relative to a traditionally manufactured ultrasonic titanium tire cutting horn.

The foregoing description of the embodiments has been provided for purposes of illustration and description. It is not intended to be exhaustive or to limit the disclosure. Individual aspects or features of a particular embodiment are generally not limited to that particular embodiment, but, where applicable, are interchangeable and can be used in a selected embodiment, even if not specifically shown or described. It is expressly contemplated that any aspect or feature of the present disclosure can be combined with any other aspect or combination of aspects disclosed herein. The method steps, processes, and operations described herein are not to be construed as necessarily requiring their performance in the particular order discussed, unless specifically identified as an order of performance. It is also to be understood that additional or alternative steps may be employed. All such variations, combinations, and modifications are not to be regarded as a departure from the disclosure, and all such variations, combinations, and modifications are intended to be included within the scope of the disclosure.

What is claimed is:

1. A tire cutting ultrasonic horn comprising:
a tuned blade including a base and a tire cutting edge, wherein the tuned blade comprises a tool steel having a vanadium content which is at least about 8 percent.

2. The tire cutting ultrasonic horn according to claim 1, wherein the tool steel has a vanadium content which is at least about 9 percent and less than about 15 percent.

3. The tire cutting ultrasonic horn according to claim 1, wherein the tool steel has a combined vanadium, cobalt, and tungsten content that is at least about 15 percent.

4. The tire cutting ultrasonic horn according to claim 1, wherein the tool steel has a combined vanadium, cobalt, and tungsten content that is at least about 17 percent and less than about 22 percent.

5. The tire cutting ultrasonic horn according to claim 1, wherein the tool steel is formed by a powder metallurgy process to have a finer grained microstructure than that of traditional steel casting processes.

6. The tire cutting ultrasonic horn according to claim 1, wherein the tool steel has a Rockwell hardness of at least about 50 HRC and less than about 64 HRC.

7. The tire cutting ultrasonic horn according to claim 1, wherein the tool steel has a Rockwell hardness of at least about 60 HRC and less than about 64 HRC.

8. The tire cutting ultrasonic horn according to claim 1, wherein the tuned blade further comprises a low friction coating over the tool steel.

9. The tire cutting ultrasonic horn according to claim 1, wherein the tuned blade further comprises a wear resistant coating over the tool steel.

10. The tire cutting ultrasonic horn according to claim 1, wherein the tuned blade further comprises a titanium nitride coating over the tool steel.

11. An ultrasonic tire cutting horn manufacturing method comprising:
mixing powdered components for a tool steel having a vanadium content which is at least about 8 percent;
forming the powdered components into a simple block of a tool steel via a powder metallurgy process;
milling the simple block of tool steel into an ultrasonic tire cutting horn shape comprising a tuned blade including a base and a tire cutting edge;
heat treating the ultrasonic tire cutting horn to provide the tool steel with a Rockwell hardness of at least about 50 HRC and less than about 64 HRC;
sharpening the tire cutting edge.

12. The ultrasonic tire cutting horn manufacturing method according to claim 11, wherein the mixing comprises mixing powdered components for a tool steel having a vanadium content which is at least about 9 percent and less than about 15 percent.

13. The ultrasonic tire cutting horn manufacturing method according to claim 11, wherein the mixing comprises mixing powdered components for a tool steel having a combined vanadium, cobalt, and tungsten content that is at least about 15 percent and less than about 25 percent.

14. The ultrasonic tire cutting horn manufacturing method according to claim 11, wherein the mixing comprises mixing powdered components for a tool steel having a combined vanadium, cobalt, and tungsten content that is at least about 17 percent and less than about 22 percent.

15. The ultrasonic tire cutting horn manufacturing method according to claim 11, wherein the milling comprises an electrical discharge machining process.

16. The ultrasonic tire cutting horn manufacturing method according to claim 11, wherein the heat treating provides the tool steel with a Rockwell hardness of at least about 60 HRC and less than about 64 HRC.

17. The tire cutting ultrasonic horn according to claim 1, wherein the heat treating provides the tool steel with a Rockwell hardness of at least about 62 HRC and less than about 64 HRC.

18. The ultrasonic tire cutting horn manufacturing method according to claim 11, further comprising:
coating the heat treated ultrasonic tire cutting horn with a low friction coating.

19. The ultrasonic tire cutting horn manufacturing method according to claim 11, further comprising:
coating the heat treated ultrasonic tire cutting horn with a wear resistant coating.

20. The ultrasonic tire cutting horn manufacturing method according to claim 11, further comprising:
coating the heat treated ultrasonic tire cutting horn with a titanium nitride coating.
